(19) United States
(12) Patent Application Publication
(10) Pub. No.: US 2021/0256524 A1
(43) Pub. Date: Aug. 19, 2021

(54) REAL-TIME RESOURCE TRACKING AND LOOKUP FACILITY

(71) Applicant: BANK OF AMERICA CORPORATION, Charlotte, NC (US)

(72) Inventor: Therese H. Willis, Apopka, FL (US)

(73) Assignee: BANK OF AMERICA CORPORATION, Charlotte, NC (US)

(21) Appl. No.: 16/793,708

(22) Filed: Feb. 18, 2020

(51) Int. Cl. G06Q 20/40; G06Q 40/02; G06Q 20/36; G06Q 50/26; G06Q 20/38

(52) U.S. Cl. CPC G06Q 20/4016; G06Q 40/02; G06Q 20/385; G06Q 20/367; G06Q 50/265; G06Q 20/363

(57) ABSTRACT

Embodiments of the present invention provide a real-time resource distribution lookup facility for facilitating real-time resource distributions via a universal channel functionality number. The invention commodities specific routing and transit numbers into universal channel functionality numbers tied directly to a real-time resource distribution. Upon initiation of a real-time resource distribution, the invention may recognize the functionality numbers and process the real-time resource distribution request via the lookup facility. The invention may identify the user, qualifications, and standing for confirmation of the real-time resource distribution and allow for processing of the distribution using the functionality number, which provides security and anonymity for the user and real-time resource distribution request from outside exposure.

### BACKGROUND

Resource tracking and real-time resource distribution channel identification is becoming difficult as parties merge and transition. Specifically, the identification of the real-time resource distribution channel based on routing numbers is challenge as they are continually co-mingled.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

In resource distribution processing networks, a need exists to have the ability to verify a third party account prior to transmission of a real-time resource distribution. Currently, in order to verify a third party account prior to transmission of a real-time resource distribution, they use of the external account needs to be verified to ensure the customer is the owner or has legal access to the funds in that external account and that the account is in good standing at the external financial institution. Currently, there are two ways to do this verification. First, via a third party service that aggregates information from all financial institutions and generates a centralized place for querying for verification of the account of the third party and that the account can be used for payments or monetary transactions. Second, via a trial deposit method, where random resource amounts may be distributed and deposited in to the third party account and the user must confirm back the values of those deposits.

In some embodiments, the invention allows all real-time payment network participating institutions to directly control the validation of accounts to anyone else on the network.

Embodiments of the present invention address the above needs and/or achieve other advantages by providing apparatuses (e.g., a system, computer program product and/or other devices) and methods for real-time resource distribution lookup, the invention comprising commoditizing a functionality number for all real-time resource distributions, wherein the functionality number is for all resource distributions via a real-time resource distribution channel irrespective of a user; receiving a real-time resource distribution with the functional number from a hub; processing the received functional number via a real-time resource distribution lookup application; performing stand in processing of confirmation of qualifications, standing and limit for the real-time resource distribution of the user, wherein the stand in processing is performed based on data pre-populated within the real-time resource distribution lookup application; and allowing for resource distribution via real-time resource distribution network.

In some embodiments, the real-time resource distribution lookup application comprises a remapping application with alias lookup, provisioning data look up, user account lookup, and real-time resource distribution criteria for the user.

In some embodiments, performing stand in processing further comprises performing misappropriation review of the real-time resource distribution to prevent misappropriation of resources prior to distribution.

In some embodiments, the invention further comprises using the functionality number for back end reconciliation of resource distribution channel type. In some embodiments, the invention further comprises tokenizing user information and transmit the tokenized information with the functionality number for the real-time resource distribution lookup channel.

In some embodiments, the functionality number is a routing and transit number used to process the real-time resource distribution outside of an entity.

In some embodiments, receiving a real-time resource distribution with the functional number from a hub, further comprises the user initiating a real-time resource distribution via a real-time payment network.

In some embodiments, the functionality number is used to process the real-time resource distribution outside the entity and provide limited exposure to the user, wherein the functionality number is used for all real-time resource distributions, not specific accounts for the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1A illustrates a diagram illustrating a system environment for real-time resource lookup, in accordance with an embodiment of the invention.

FIG. 1B illustrates a block diagram illustrating a system environment for real-time resource lookup processing, in accordance with an embodiment of the invention.

FIG. 2 provides a block diagram illustrating the resource lookup facility system of FIG. 1B, in accordance with an embodiment of the invention;

FIG. 3 provides a block diagram illustrating the computing device system of FIG. 1B, in accordance with an embodiment of the invention;

FIG. 4 provides a flowchart illustrating a real-time resource tracking and lookup, in accordance with embodiments of the invention; and

FIG. 5 provides a flowchart illustrating a process for real-time resource distribution processing with a functionality number, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

A “user” as used herein may refer to any customer of an entity or individual that interacts with an entity. The user may interact with an entity as a customer, such as a customer purchasing a product or service. Furthermore, as used herein the term “user device” or “mobile device” may refer to mobile phones, personal computing devices, tablet computers, wearable devices, and/or any portable electronic device capable of receiving and/or storing data therein.

As used herein, a “user interface” generally includes a plurality of interface devices and/or software that allow a customer to input commands and data to direct the processing device to execute instructions. For example, the user interface may include a graphical user interface (GUI) or an interface to input computer-executable instructions that direct the processing device to carry out specific functions. Input and output devices may include a display, mouse, keyboard, button, touchpad, touch screen, microphone, speaker, LED, light, joystick, switch, buzzer, bell, and/or other user input/output device for communicating with one or more users.

A “technology activity” may include a transaction for a product or service from a merchant. A “transaction” or “resource distribution” refers to any communication between a user and an entity to transfer funds for the purchasing or selling of a product or service. A transaction may refer to a purchase of goods or services, a return of goods or services, a payment transaction, a credit transaction, or other interaction involving a user's account. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In some embodiments, the transaction may refer to a technology activity such as an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

Further, the term “payment credential” or “payment vehicle,” as used herein, may refer to any of, but is not limited to refers to any of, but is not limited to, a physical, electronic (e.g., digital), or virtual transaction vehicle that can be used to transfer money, make a payment (for a service or good), withdraw money, redeem or use loyalty points, use or redeem coupons, gain access to physical or virtual resources, and similar or related transactions. For example, in some embodiments, the payment vehicle is a bank card issued by a bank which a customer may use to perform purchase transactions. However, in other embodiments, the payment vehicle is a virtual debit card housed in a mobile device of the customer, which can be used to electronically interact with an ATM or the like to perform financial transactions. Thus, it will be understood that the payment vehicle can be embodied as an apparatus (e.g., a physical card, a mobile device, or the like), or as a virtual transaction mechanism (e.g., a digital transaction device, digital wallet, a virtual display of a transaction device, or the like). The payment vehicle may be an unrestricted resource. Unrestricted resources, as used herein may be any resource that is not restricted for transaction. In this way, the unrestricted resources may be applied to any transaction for purchase of a product or service.

Functionality number, as used herein may be similar to a routing and transit number for a resource distribution, to facilitating the sorting, bundling, and processing of the resources associated with the resource distribution. A real-time resource distribution may be a real-time payment using a real-time payment network for clearing and settling resource distributions in real-time. The functionality number may be numeric, alpha-numeric, or the like.

Embodiments of the present invention provide a real-time resource distribution lookup facility for facilitating real-time resource distributions via a universal channel functionality number. The invention commodities specific routing and transit numbers into universal channel functionality numbers tied directly to a real-time resource distribution. Upon initiation of a real-time resource distribution, the invention may recognize the functionality numbers and process the real-time resource distribution request via the lookup facility. The invention may identify the user, qualifications, and standing for confirmation of the real-time resource distribution and allow for processing of the distribution using the functionality number, which provides security and anonymity for the user and real-time resource distribution request from outside exposure.

One challenge across the enterprise with respect to mergers within the financial sector, routing and transit numbers for real-time resource distribution transactions get co-mingled and become difficult to identify. This system commoditizes specific routing and transit numbers into a functionality number for use as transaction capability tagged to a specific account time. As such, the system assigns routing and transit numbers to a specific function as a functionality number. This way, a functionality number would be assigned to a user who signed up with a token and the system would leverage and expose that routing and transit number as the real-time payment routing and transit number. With respect to the bank as a biller transaction type, the system identifies how credit card statements are exposed to users. As such, instead of having multiple routing and transit numbers for each location, the system assigns a single functionality number to a credit card number, that can be tracked back to the system of record. This system simplifies what is exposed externally and simplifies how to manage internal routing and transit numbers. There are two methods, when a transaction is being initiated and when maintenance is being initiated as described in more detail below.

A system leveraging a real-time interaction settlement network allows for an interaction, transaction, payment, or the like to be completed between participating parties (e.g., financial institutions and/or their customers) via an intermediary clearing house acting in the role of a neutral party. Participant accounts are held at the clearing house and administered by both the participant and the clearing house. In this way, the clearing house is able to transfer resources or funds between the participant accounts on behalf of the participants in order to settle interactions.

Currently upon resource transfers the resources are not distributed in real-time. Typically, a credit or indication of the transfer is posted, but requires and end of day batch processing transfer from one entity to the other to settle the resource distribution. This typically takes a day or more to complete. The invention solves this computer batch processing problem by building and providing a settlement processing hub for real-time interaction and resource distribution approval and settlement process.

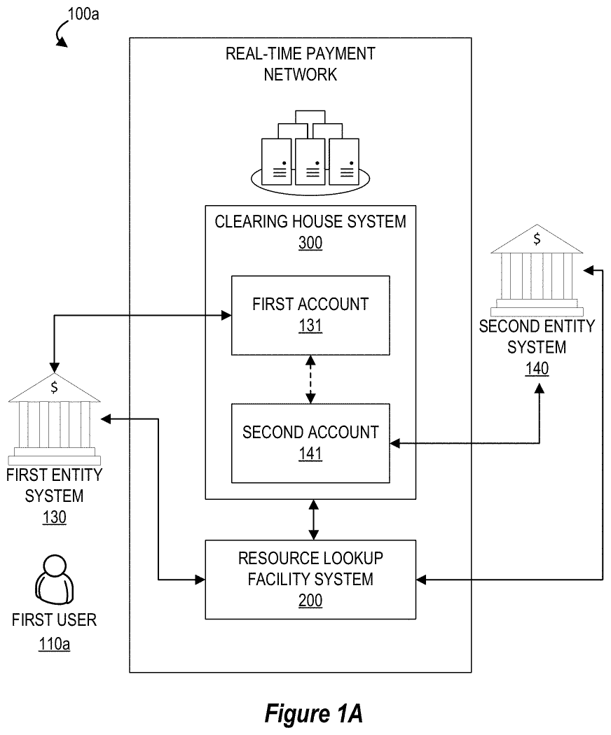

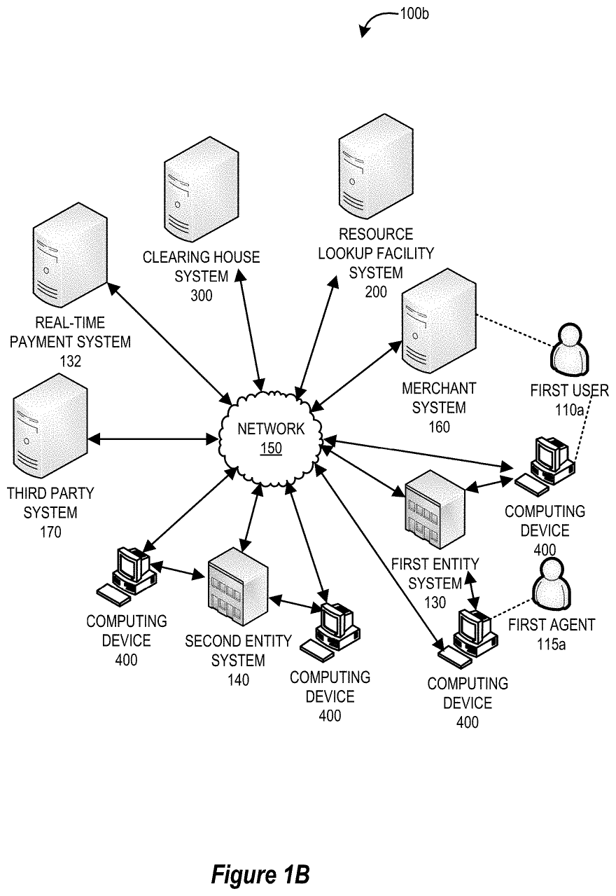

FIG. 1A illustrates a system environment for real-time resource lookup 100a, in accordance with one embodiment of the invention. In some embodiments, the clearing house 300 is associated with the real-time resource distribution network. In the illustrated environment, a user 110a is associated with (i.e., a customer of) a first entity system 130. A clearing house system 300 comprises a first entity account 131 associated with the first entity system 130 and a second entity account 141 associated with the second entity system 140. A resource lookup facility system 200 that communicably links across the entities and clearing house to provide lookup information, account information, and processing to a real-time resource distribution with functionality numbers for routing and transit. The first entity account 131 and the second entity account 141 are accessible by each associated financial institution, the resource lookup facility system 200, and the clearing house system 300 which acts as a trusted intermediary during the verification, transfer, and settlement between the financial institutions. Resources or funds may be transferred by each financial institution to and from their associated account. Transfers between the first entity account 131 and the second entity account 141 are administered by the clearing house system 300 and resource lookup facility system 200 pending authentication and authorization by participating parties of each transfer.

In one embodiment, the first user 110a may request a product or service of a second entity system 140, wherein the first user 110a may be required to provide information about a funding account for product processing. In a specific example, the first user 110a is required to initiate the transfer from the first entity system 130, wherein the first user 110a provides authentication information to authenticate the identity of the first user 110a and to validate that an account of the first user 110a held at the first entity system 130 contains at least a sufficient amount of available funds to fulfill funding account requirements.

The first user 110a, as the sending participant (i.e., payor), is required to authenticate his or her identity by providing information or credentials to the associated financial institution. For example, authentication information may include account numbers, routing numbers, PIN numbers, username and password, date of birth, social security number, or the like, or other authentication information as described herein. In some embodiments, authentication may comprise multi-factor or multi-step authentication in accordance with information security standards and requirements.

Upon initiating an interaction, the first user 110a becomes obligated to a status within a funding account for processing the product at the second entity system 140 associated with a second financial institution. The resource lookup facility system 200 monitors the communications and confirms the communications and fund transfers into the first or second account accurately and provides expedited reconciliation of the transaction. The transfer of funds occurs between the first entity account 131 and second entity account 141 associated with the first entity system 130 and the second entity system 140 on behalf of the user, wherein the interaction may be settled immediately, concurrent with the interaction. As settlement occurs between the representative financial institutions, debiting and crediting of individual user accounts may be managed at each financial institution with their associated customers. As the interaction is settled immediately, funds may be made available for use in real or near real-time.

It should be understood that while the illustrated embodiment of FIG. 1A depicts only a first user, financial institutions, and accounts, other embodiments of a real-time interaction network may comprise a plurality of accounts associated with a plurality financial institutions. In some embodiments, the system environment 100a may further comprise more than one clearing house system 300 (e.g., TCH, the Federal Reserve, and the like) that receive and process interaction requests as described herein. Financial institutions may include one or more community banks, regional banks, credit unions, corporate banks, direct connect financial institutions, and the like.

In accordance with embodiments of the invention, the terms “entity system” may include any organization such as one that processes financial transactions including, but not limited to, financial institutions, banks, credit unions, savings and loan associations, card associations, settlement associations, investment companies, stock brokerages, asset management firms, insurance companies and the like. Furthermore, embodiments of the present invention use the term “user” or “customer.” It will be appreciated by someone with ordinary skill in the art that the user or customer may be a customer of the financial institution or a potential customer of the entity (e.g., a financial institution) or an employee of the entity.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

FIG. 1B provides a block diagram illustrating a system environment for real-time resource lookup processing 100b. As illustrated in FIG. 1B, the environment 100 includes a real-time payment system 132, a resource lookup facility system 200, a clearing house system 300, a first entity system 130, a second entity system 140, one or more computing device systems 400, a merchant system 160, and one or more third party systems 170.

The real-time payment network, upon utilization by multiple financial institutions, will have the data processing power of the third party services that aggregate the information from all financial institutions. One or more users, including a first user 110a, may be in network communication with the first entity system 130, the second entity system 140, or the other systems of the system environment 100b via a computing device system 400. The user may be a customer, client, patron, individual, business, or the like associated with the first entity system 130.

Similarly, one or more agents, including a first agent 115a may be in network communication with the first entity system 130, the second entity system 140, or the other systems of the system environment 100b via a computing device system 400. These agents may be employees, contractors, consultants, claim investigators, claim analysts, transaction analysts, or the like, for the first entity system 130 and/or the second entity system 140.

The real-time payment system 132, resource lookup facility system 200, the clearing house system 300, the first entity system 130, the second entity system 140, the one or more computing device systems 400, the merchant system 160, and the one or more third party systems 170 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet.

The resource lookup facility system 200 may be a system owned or otherwise controlled by a managing entity to perform one or more process steps described herein. In some embodiments, the managing entity is a financial institution, a clearing house entity, a consortium of financial institutions and/or clearing house entities, or the like. While the resource lookup facility system 200 is shown as a separate entity from other systems in the system environment 100b, it should be known that the managing entity may comprise one or more of the other systems in the system environment 100b.

In general, resource lookup facility system 200 is configured to communicate information or instructions with the clearing house system 300, the first entity system 130, the second entity system 140, the one or more computing device systems 400, the merchant system 160, and/or one or more third party systems 170 across the network 150. Of course, the resource lookup facility system 200 may be configured to perform (or instruct other systems to perform) one or more other process steps described herein.

As noted above with respect to FIG. 1A, the clearing house system 300 may be a system owned or controlled by the managing entity and/or a third party that specializes in maintaining financial accounts, performing financial transaction clearing house functions, generating and/or transmitting financial transaction messages, and the like. In general, the clearing house system 300 is configured to communicate information or instructions with the real-time payment system 132, resource lookup facility system 200, the first entity system 130, the second entity system 140, the one or more computing device systems 400, the merchant system 160, and/or the third party system 170 across the network 150. For example, the clearing house system 300 may be configured to receive a message from a computing device system 400 associated with the first user 110a and/or the first entity system 130, transfer an event amount from an account of the first entity system 130 to an account of the second entity system 140, record event information in a clearing house database system, receive a request for the event information along with an event request indicia, and/or extract and transmit the event information stored in the clearing house database system Of course, the clearing house system 300 may be configured to perform (or instruct other systems to perform) one or more other process steps described herein.

The one or more computing device system(s) 400 may be a system owned or controlled by the managing entity, a merchant entity (e.g., a merchant associated with the merchant system 160) and/or a third party that specializes in providing computing devices and/or mobile computing devices to users. In general, a computing device system 400 is configured to provide a communication and/or transaction interface for the first user 110a to provide instructions to, or receive notifications from, the real-time payment system 132, resource lookup facility system 200, the clearing house system 300, the first entity system 130, the second entity system 140, the merchant system 160, and/or the third party system 170 across the network 150. For example, the computing device system 400 associated with the first user 110a may be configured to receive an event request from the first user 110a, generate a message based on the event request (e.g., via an event application stored in the memory of the computing device system 400), and transmit the message and/or event request to the first entity system 130. Of course, the computing device system 400 may be configured to perform (or instruct other systems to perform) one or more other process steps described herein.

The first entity system 130 may comprise a network communication interface, a processing device, and one or more memory devices, where the processing devices are configured to perform certain actions with the memory devices and communicate these actions to the rest of the network 150 through its network communication interface. In some embodiments, the first entity system 130 comprises a financial institution at which the first user 110a is a customer. The first entity system 130 may have one or more financial accounts that are available to, at least partially controlled by, or otherwise accessible by the clearing house system 300 such that the clearing house system 300 is pre-authorized to execute transactions with the account of the first entity system 130 upon receipt of messages from the first entity system 130, the second entity system 140, and/or the first user 110a.

The second entity system 140 may comprise a network communication interface, a processing device, and one or more memory devices, where the processing devices are configured to perform certain actions with the memory devices and communicate these actions to the rest of the network 150 through its network communication interface. The second entity system 140 may have one or more financial accounts that are available to, at least partially controlled by, or otherwise accessible by the clearing house system 300 such that the clearing house system 300 is pre-authorized to execute transactions with the account of the second entity system 140 upon receipt of messages from the first entity system 130, the second entity system 140, and/or the first user 110a.

The merchant system 160 may be a system owned, operated, managed, or otherwise controlled by a merchant entity (e.g., a business or individual that offers goods or services in return for payment). The merchant system 160 may include or comprise a computing device system 400 as described herein. In some embodiments, the computing device system 400 of the merchant system 160 comprises a point of sale (POS) device or system of devices, barcode scanning devices, universal product code (UPC) scanners, receipt generating and/or printing devices, security video monitoring system devices, card reading devices, near field communication (NFC) chip reading devices, or other transaction, security, or recording devices that the merchant entity can use to process or document a transaction between the merchant entity and a user (e.g., the first user 110a).

The merchant system 160 may be configured to begin processing certain transactions with the first user 110a by receiving payment information of the first user 110a (e.g., scanning a financial instrument like a credit card of the user 110a that is associated with a financial account of the first user 110a, receiving a transmission of financial account information from the computing device system 400 of the user 110a, receiving payment credentials of the first user 110a via an online merchant portal established or managed by the merchant system 160, or the like). The merchant system 160 may then transmit transaction information to the first entity system 130 (and not through a traditional credit or debit card processing network), either by providing the transaction information to the first agent 115a or by entering the transaction information into a predetermined template that the first entity system 130 is configured to automatically convert into a message for the clearing house system 300 and/or the second entity system 140.

The third party system 170 may be any system that is in communication with the network 150 and executes one or more functions or process steps of the processes described herein with respect to the system environment 100b.

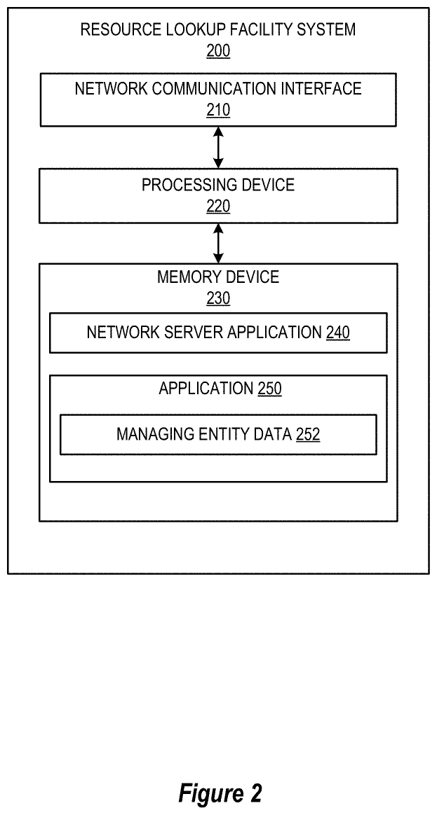

FIG. 2 provides a block diagram illustrating the resource lookup facility system 200, in greater detail, in accordance with embodiments of the invention. As illustrated in FIG. 2, in one embodiment of the invention, the resource lookup facility system 200 includes one or more processing devices 220 operatively coupled to a network communication interface 210 and a memory device 230. In certain embodiments, the resource lookup facility system 200 is operated by a first entity, such as a financial institution, while in other embodiments, the resource lookup facility system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the resource lookup facility system 200 described herein. For example, in one embodiment of the resource lookup facility system 200, the memory device 230 includes, but is not limited to, a network server application 240, a reconciliation application 250 which includes reconciliation data 252 and other computer-executable instructions or other data. The computer-executable program code of the network server application 240 and/or the reconciliation application 250 may instruct the processing device 220 to perform certain logic, data-processing, and data-storing functions of the resource lookup facility system 200 described herein, as well as communication functions of the resource lookup facility system 200.

The application 250 may be configured to invoke or use the data 252 to perform one or more processes and functions of the other systems (i.e., the clearing house system 300, the first entity system 130, the second entity system 140, the merchant system 160, the third party system 170, and/or the one or more computing device systems 400) within the system environment 100b, as defined or described herein.

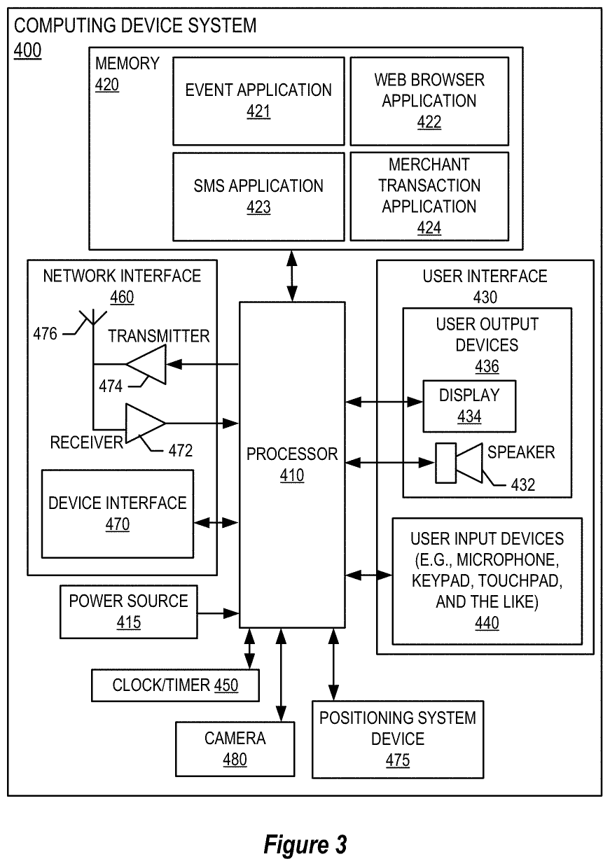

FIG. 3 provides a block diagram illustrating an example computing device system 400 of FIG. 1B in more detail, in accordance with embodiments of the invention. In one embodiment of the invention, the computing device system 400 is a mobile telephone. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of a wireless network. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA resource lookup facility system 2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422 and/or an event application 421 (or any other application provided by the resource lookup facility system 200 and/or the clearing house system 300). These applications also typically instructions to a graphical user interface (GUI) on the display 430 that allows the user 110 to interact with the computing device system 400, the resource lookup facility system 200, and/or other devices or systems. In one embodiment of the invention, when the user (e.g., user 110a) decides to enroll in an event application 421 program, the user downloads, is assigned, or otherwise obtains the event application 421 from the resource lookup facility system 200, the clearing house system 300, the first entity system 130, the second entity system 140, or from a distinct application server. In other embodiments of the invention, the user 110 interacts with the real-time payment system 132, resource lookup facility system 200, the clearing house system 300, the first entity system 130, the second entity system 140, a third party system, or another computing device system 400 via the web browser application 422 in addition to, or instead of, the event application 421.

The event application 421 may be configured to transmit and receive messages, notifications, calls, electronic mail messages, and the like, between a user and an entity associated with the event (e.g., a first entity system, a second entity system, and/or a clearing house system). In this way, the event application 421 acts as a communication interface that allows the user to perform any of the user-controlled or initiated actions described herein.

The memory 420 of the computing device system 400 may comprise a Short Message Service (SMS) application 423 configured to send, receive, and store data, information, communications, alerts, and the like via a wireless telephone network.

In embodiments where the computing device system 400 is owned, managed, or otherwise controlled by the merchant system 160, the memory 420 may include a merchant transaction application 424 that is configured to perform certain tasks associated with identifying products or services being purchased, initiating the processing of financial instruments being used to purchase the products or services, generating receipt information associated with transactions, recording supplemental information associated with products or services being purchased, and the like. For example, the merchant transaction application 424 may be configured to scan barcode information or otherwise identify a UPC for a product being purchased at a merchant location. The merchant transaction application 424 may additionally be configured to cause the camera 480 to acquire an image and/or video media of a region around or associated with a point of sale terminal (e.g., a component of the computing device system 400 of the merchant system 160) to record information about an individual engaging in a transaction with the merchant entity, and this media can be stored or otherwise recorded as additional information for the transaction or event.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

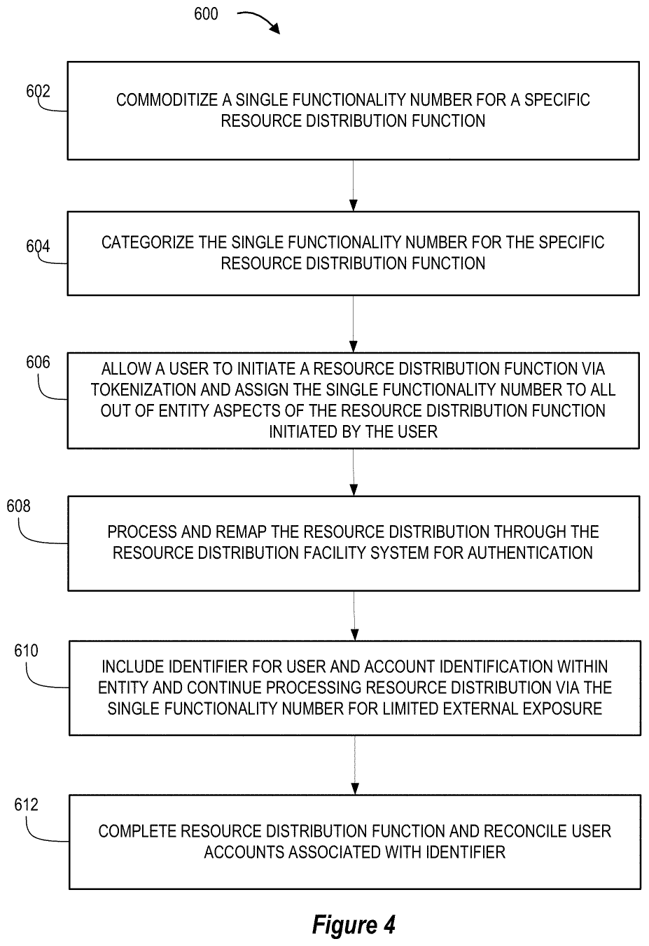

FIG. 4 provides a flowchart illustrating a real-time resource tracking and lookup 600, in accordance with embodiments of the invention. As illustrated in block 602, the process 600 is initiated by commoditizing a single functionality number for a specific resource distribution function. Currently, several routing and transit numbers are used for location specific, bank specific, or user specific transactions. However, due to co-mingling and use across various entities, it is challenging to identify if the routing and transit number associated with a transaction is a real-time resource distribution transaction or not. As such, the system creates a single functionality number that is used as a routing and transit number for all real-time resource distribution transactions, irrespective of the user or the location. Furthermore, the system may utilize a functionality number for other transaction categories, such as bank as the biller, credit, mortgage, or the like type of categories of transactions.

Next, as illustrated in block 604, the process 600 continues by categorizing the single functionality number for the specific resource distribution function. In this way, the single functionality number may be a routing transit number specific for indication of a transaction being performed across a real-time resource distribution network. In other embodiments, a single functionality number may be used for other resource distribution channels.

As illustrated in block 606, the process 600 continues by allowing a user to initiate a resource distribution function via tokenization and assign the single functionality number associated with the function to all out of entity aspects of the resource distribution function processing. As such, the system assigns routing and transit numbers to a specific function. This way, a functionality number would be assigned to a user who signed up with a token and the system would leverage and expose that functionality number as a real-time resource distribution routing and transit number. As such, instead of having multiple routing and transit numbers for each location, the system assigns a single functionality number to a credit card number, that can be tracked back to the system of record. This system simplifies what is exposed externally and simplifies how to manage internal routing and transit numbers.

As illustrated in block 608, the process 600 continues by processing and remapping the resource distribution request through the resource distribution facility system for authentication. In this way, the system may recognize the functionality number and transmit it to the lookup application for confirmation prior to allowing resource distribution.

The invention may identify the user associated with the resource distribution request based on token or user information tagged in association with the functionality number. In this way, the system may tag and include a user identifier within the functionality number transaction in order to remap within the system to identify account status, account types, hosts, and funds for authorization for that type of transaction. As illustrated in block 610 using the identifier the system may identify the user and account information and continue processing the resource distribution via the functionality number for limited external exposure.

Finally, as illustrated in block 612, the process 600 is finalized by completing the resource distribution function and allowing for subsequent reconciliation of channel based on the use of the functionality number.

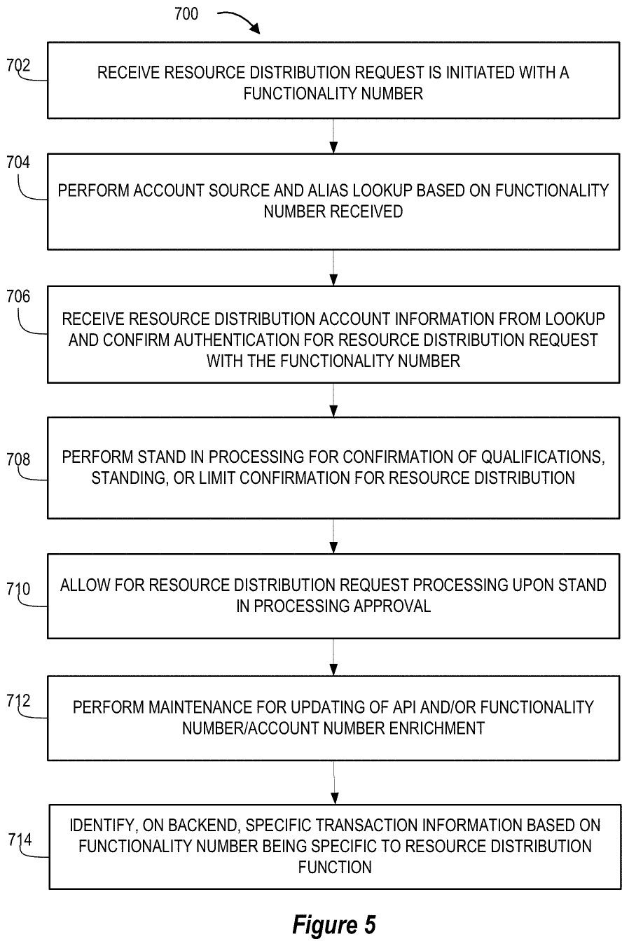

FIG. 5 provides a flowchart illustrating a process for real-time resource distribution processing with a functionality number 700, in accordance with embodiments of the invention. As illustrated in block 702, the process 700 is initiated by receiving a resource distribution request that is initiated with a functionality number. The system may recognize that the functionality number is associated with a real-time resource distribution and is processed via the system.

Since it is a real-time resource distribution, the system may perform an account source and alias lookup based on the functionality number and associated token received, as illustrated in block 704. In some embodiments, the alias lookup may be performed by accessing an alias directory associated with the entity system. The alias may be associated with a user account and set up for performing P2P or other real-time resource distributions using the alias. Upon identification of the alias, the system may be able to identify the account associated with the alias and process the resource distribution request accordingly. In some embodiments, no alias lookup is necessary. As such, the system may perform an account lookup based on the functionality number and token provided via the transaction.

As illustrated in block 706, the system may receive the resource distribution account information from the lookup processes and confirm authentication for the resource distribution request via real-time resource distribution with the functionality number. As such, once the account is identified with the alias or otherwise, the system may redrive provision data and account data with respect to the real-time resource distribution from consumer and commercial hosts.

Next, once the transaction parties are identified, the amount for the transaction is identified, and the account associated with the real-time resource distribution is identified, the system may perform stand in processing for confirmation of qualifications, standing, and limit satisfaction for the resource distribution via the real-time resource distribution, as illustrated in block 708. In this way, the system may confirm the user and user account are authorized for a real-time resource distribution transaction. Furthermore, the system may identify if one or more thresholds such as limits or the like for the account for the real-time resource distribution transaction have been met.

Once the stand in processing has been performed and authorization has been granted, the process 700 may continue by allowing for the real-time resource distribution request for continued processing using the functionality number, as illustrated in block 710.

As illustrated in block 712, the process 700 continues by performing maintenance for the updating of application program interfaces and/or account number enrichment. In this way, the second initiation of the system is when maintenance is being performed. The system may update interfaces and gain access to the lookup applications for message transformation, message and screen updates, account updates, and functionality number updates and modifications.

Finally, as illustrated in block 714, the process 700 is finalized by allowing for easy backend review and modification based on identification, on the backend, specific transaction information based on the functionality number being assigned to a specific resource distribution function.

Embodiments of the present invention provide a real-time resource distribution lookup facility for facilitating real-time resource distributions via a universal channel functionality number. The invention commodities specific routing and transit numbers into universal channel functionality numbers tied directly to a real-time resource distribution. Upon initiation of a real-time resource distribution, the invention may recognize the functionality numbers and process the real-time resource distribution request via the lookup facility. The invention may identify the user, qualifications, and standing for confirmation of the real-time resource distribution and allow for processing of the distribution using the functionality number, which provides security and anonymity for the user and real-time resource distribution request from outside exposure.

One challenge across the enterprise with respect to mergers within the financial sector, routing and transit numbers for real-time resource distribution transactions get co-mingled and become difficult to identify. This system commoditizes specific routing and transit numbers into a functionality number for use as transaction capability tagged to a specific account time. As such, the system assigns routing and transit numbers to a specific function as a functionality number. This way, a functionality number would be assigned to a user who signed up with a token and the system would leverage and expose that routing and transit number as the real-time payment routing and transit number. With respect to the bank as a biller transaction type, the system identifies how credit card statements are exposed to users. As such, instead of having multiple routing and transit numbers for each location, the system assigns a single functionality number to a credit card number, that can be tracked back to the system of record. This system simplifies what is exposed externally and simplifies how to manage internal routing and transit numbers. There are two methods, when a transaction is being initiated and when maintenance is being initiated as described in more detail above.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for real-time resource distribution lookup, the system comprising:
a memory device; and
a processing device operatively coupled to the memory device, wherein the processing device is configured to execute computer-readable program code to:
commoditize a functionality number for all real-time resource distributions that is used as a routing and transit number for all real-time resource distribution, wherein the functionality number is for all real-time resource distributions irrespective of a user and a location;
receive a real-time resource distribution request, wherein the real-time resource distribution request is a user initiating a resource distribution function via tokenization;
process a received functional number associated with the real-time resource distribution request via a real-time resource distribution lookup application;
remap the received functional number associated with the real-time resource distribution request to authenticate a real-time resource distribution associated with the real-time resource distribution request;
perform stand in processing of confirmation of qualifications, standing and limit for the real-time resource distribution of the user, wherein the stand in processing is performed based on data pre-populated within the real-time resource distribution lookup application;
allow for resource distribution via real-time resource distribution network;
perform backend review by identification of transaction information based on the functional number assignment to the real-time resource distribution and the resource distribution function.

2. The system of claim 1, wherein the real-time resource distribution lookup application comprises a remapping application with alias lookup, provisioning data look up, user account lookup, and real-time resource distribution criteria for the user.

3. The system of claim 1, wherein performing stand in processing further comprises performing misappropriation review of the real-time resource distribution to prevent misappropriation of resources prior to distribution.

4. The system of claim 1, further comprising using the functionality number for back end reconciliation of resource distribution channel type.

5. The system of claim 1, further comprising tokenizing user information and transmit the tokenized information with the functionality number for the real-time resource distribution lookup channel.

6. The system of claim 1, wherein the functionality number is a routing and transit number used to process the real-time resource distribution outside of an entity.

7. The system of claim 1, wherein receiving a real-time resource distribution with the functional number from a hub, further comprises the user initiating a real-time resource distribution via a real-time payment network.

8. The system of claim 1, wherein the functionality number is used to process the real-time resource distribution outside the entity and provide limited exposure to the user, wherein the functionality number is used for all real-time resource distributions, not specific accounts for the user.

9. A computer program product for real-time resource distribution lookup, the computer program product comprising at least one non-transitory computer-readable medium having computer-readable program code portions embodied therein, the computer-readable program code portions comprising:
an executable portion configured for commoditizing a functionality number for all real-time resource distributions that is used as a routing and transit number for all real-time resource distribution, wherein the functionality number is for all real-time resource distributions irrespective of a user and a location;
an executable portion configured for receiving a real-time resource distribution request, wherein the real-time resource distribution request is a user initiating a resource distribution function via tokenization;
an executable portion configured for processing a received functional number associated with the real-time resource distribution request via a real-time resource distribution lookup application;
an executable portion configured for performing stand in processing of confirmation of qualifications, standing and limit for the real-time resource distribution of the user, wherein the stand in processing is performed based on data pre-populated within the real-time resource distribution lookup application;
an executable portion configured for allowing for resource distribution via real-time resource distribution network;
an executable portion configured for performing backend review by identification of transaction information based on the functional number assignment to the real-time resource distribution and the resource distribution function.

10. The computer program product of claim 9, wherein the real-time resource distribution lookup application comprises a remapping application with alias lookup, provisioning data look up, user account lookup, and real-time resource distribution criteria for the user.

11. The computer program product of claim 9, wherein performing stand in processing further comprises performing misappropriation review of the real-time resource distribution to prevent misappropriation of resources prior to distribution.

12. The computer program product of claim 9, further comprising an executable portion configured for tokenizing user information and transmit the tokenized information with the functionality number for the real-time resource distribution lookup channel.

13. The system of claim 1, wherein the functionality number is a routing and transit number used to process the real-time resource distribution outside of an entity.

14. The computer program product of claim 9, wherein receiving a real-time resource distribution with the functional number from a hub, further comprises the user initiating a real-time resource distribution via a real-time payment network.

15. The computer program product of claim 9, wherein the functionality number is used to process the real-time resource distribution outside the entity and provide limited exposure to the user, wherein the functionality number is used for all real-time resource distributions, not specific accounts for the user.

16. A computer-implemented method for real-time resource distribution lookup, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
commoditizing a functionality number for all real-time resource distributions that is used as a routing and transit number for all real-time resource distribution, wherein the functionality number is for all real-time resource distributions irrespective of a user and a location;
receiving a real-time resource distribution request, wherein the real-time resource distribution request is a user initiating a resource distribution function via tokenization;
processing a received functional number associated with the real-time resource distribution request via a real-time resource distribution lookup application;
remapping the received functional number associated with the real-time resource distribution request to authenticate a real-time resource distribution associated with the real-time resource distribution request;
performing stand in processing of confirmation of qualifications, standing and limit for the real-time resource distribution of the user, wherein the stand in processing is performed based on data pre-populated within the real-time resource distribution lookup application;
allowing for resource distribution via real-time resource distribution network;
perform backend review by identification of transaction information based on the functional number assignment to the real-time resource distribution and the resource distribution function.

17. The computer-implemented method of claim 16, wherein the real-time resource distribution lookup application comprises a remapping application with alias lookup, provisioning data look up, user account lookup, and real-time resource distribution criteria for the user.

18. The computer-implemented method of claim 16, wherein performing stand in processing further comprises performing misappropriation review of the real-time resource distribution to prevent misappropriation of resources prior to distribution.

19. The computer-implemented method of claim 16, further comprising tokenizing user information and transmit the tokenized information with the functionality number for the real-time resource distribution lookup channel.

20. The computer-implemented method of claim 16, wherein the functionality number is a routing and transit number used to process the real-time resource distribution outside of an entity.
